(19) United States
(12) Patent Application Publication
(10) Pub. No.: US 2013/0316102 A1
(43) Pub. Date: Nov. 28, 2013

(54) VEHICLE COMPONENT

(71) Applicant: TOYOTA BOSHOKU KABUSHIKI KAISHA, Aichi-ken (JP)

(72) Inventor: Tomohiro YOSHIDA, Aichi-ken (JP)

(73) Assignee: TOYOTA BOSHOKU KABUSHIKI KAISHA, Aichi-ken (JP)

(21) Appl. No.: 13/859,094

(22) Filed: Apr. 9, 2013

(30) Foreign Application Priority Data
May 28, 2012 (JP) 2012-121344
Mar. 28, 2013 (JP) 2013-070212

(51) Int. Cl. B62D 29/04

(52) U.S. Cl. CPC B62D 29/04
USPC 428/34.5; 428/312.6; 428/213; 428/137

(57) ABSTRACT

The vehicle component has a fibrous porous article including a base layer and a surface layer which is bonded to a surface of the base layer. The base layer has a plurality of glass fibers and a first thermoplastic resin bonding glass fibers, and the surface layer has a plurality of resin fibers and a second thermoplastic resin bonding resin fibers. The base layer may have an expanded body therein.

### INCORPORATION BY REFERENCE

The present application claims priority under 35 U.S.C. §119 of Japanese Patent Application No. 2012-121344, filed on May 28, 2012, the disclosure of which is expressly incorporated by reference herein in its entirety.

### BACKGROUND OF THE INVENTION

1. Field of the Invention

The present invention relates to a vehicle component reducing leakage or intrusion of a sound having a noise level.

2. Related Art

Attempts have been made to allow various vehicle components including an automotive part such as a duct (e.g., air intake duct (air duct)), a filter case, and an undercover to reduce unpleasant sound having a noise level. These attempts aim at preventing a situation in which noise generated by a vehicle leaks to the outside, or enters the passenger compartment, for example.

Specific examples of noise generated by a vehicle include engine intake pulsation noise that enters the passenger compartment or leaks to the outside. Intake pulsation noise has normally been reduced by providing a throttle section to a resonator or an intake pipe.

A technique has been known that reduces air column resonance that occurs in an air intake duct by forming the wall of the air intake duct using an air-permeable material. JP-A 2003-343373 and JP-A 2009-293442 disclose a technique that relates to an air intake duct formed using an air-permeable material. JP-A 2002-021660 discloses a technique that reduces intake noise by forming part of an air cleaner housing a porous material.

It is preferable that a material for forming the vehicle component does not allow water to pass through in the direction of the cross-section from one side to the other side of the material.

According to the technique described in JP-A 2003-343373, water resistance is achieved by providing an outer cover, however, this technique poses a problem in that the number of parts increases. According to the technique described in JP-A 2003-343373, a wire is used as a support member, and a nonwoven fabric or the like is supported by the support member. Since a porous member that is difficult to be used as a structural member forms the majority of the structural wall, it is difficult to provide strength sufficient to withstand negative pressure that occurs in the air intake system in various situations, and withstand a change in negative pressure. In JP-A 2009-293442, it is indispensable to provide a resin frame that supports a porous member. It is also difficult to provide strength sufficient to withstand negative pressure that occurs in the air intake system.

JP-A 2002-021660 discloses an air cleaner that is disposed in an engine air intake system, wherein at least part of the outer wall surface other than the drain part is formed of a porous material. JP-A 2002-021660 states that “The bottom wall surface of the air cleaner 2 is formed by a porous material by bonding a porous material (e.g., filter paper, nonwoven fabric, or open-cell sponge), or inserting a porous material when injection—molding the air cleaner 2, for example”. When a porous material that does not have sufficient strength is merely bonded, it is difficult to provide strength sufficient to withstand negative pressure that occurs in the air intake system. Therefore, it is considered that a frame structure formed by insertion molding is provided. However, it is difficult to provide strength sufficient to withstand negative pressure that occurs in the air intake system even if such a frame structure is provided.

### SUMMARY OF THE INVENTION

An object of the present invention is to provide a vehicle component which is formed using a fibrous porous article that can be used as a structural member, is capable of reducing leakage or intrusion of a sound having a noise level, and exhibits water resistance.

The vehicle component of the present invention includes a fibrous porous article, and the fibrous porous article has a base layer and a surface layer that is bonded to a surface of the base layer.

According to the vehicle component of the present invention, leakage or intrusion of a sound having a noise level can be reduced. For example, a noise due to a vehicular internal combustion engine or the like and noise from the outside can be reduced. Specifically, the vehicle component can suppress a situation in which noise generated by a vehicle leaks to the outside, or enters the passenger compartment. The vehicle component may suitably be used as a noise absorber having a tubular shape, a sheet-like shape, an indefinite shape, or the like. Since the fibrous porous article exhibits water resistance, the vehicle component may suitably be used as vehicle interior parts as well as vehicle exterior parts. The vehicle component also exhibits excellent rigidity and sufficient strength.

In the case where the base layer includes an expanded body, higher strength can be obtained while reducing the weight of the vehicle component.

In the case where the fibrous porous article includes a portion having a thickness t₁ and a portion having a thickness t₂, and satisfies a relationship of 2≦t₂/t₁≦10, a noise over a wide frequency range can be reduced.

In the case where the fibrous porous article has a through hole penetrating from a base layer side to a surface layer side, noise can be effectively reduced.

The vehicle component of the present invention can reduce a noise due to a vehicular internal combustion engine or the like and a noise from the outside, exhibits excellent rigidity, and exhibits excellent water resistance on the side of the surface layer. Therefore, the vehicle component can suitably used as a duct, a filter case, an undercover, an engine cover, and the like by molding the vehicle component in the shape of a sheet, a tube, or the like.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view illustrating an example of an air intake system as a vehicle component of the present invention;

FIG. 2 is a schematic view illustrating a cross-sectional structure of an example of the fibrous porous article constituting the vehicle component in the present invention;

FIG. 3 is a schematic view illustrating a cross-sectional structure of another example of the fibrous porous article constituting the vehicle component in the present invention;

FIG. 4 is a perspective view illustrating an example of an undercover (shaded part) as a vehicle component of the present invention;

FIG. 5 is an explanatory view illustrating an example of the production method of the vehicle component in the present invention;

FIG. 6 is a graph showing an example of a configuration of a base layer or a nonwoven fabric for base layer;

FIG. 7 is a graph showing a correlation between engine speed and sound pressure according to Example 2; and,

FIG. 8 is a graph showing a correlation between air permeability and sound pressure according to Example 2.

### DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

### 1. Vehicle Component

Hereinafter, the present invention is described in detail with reference to drawings.

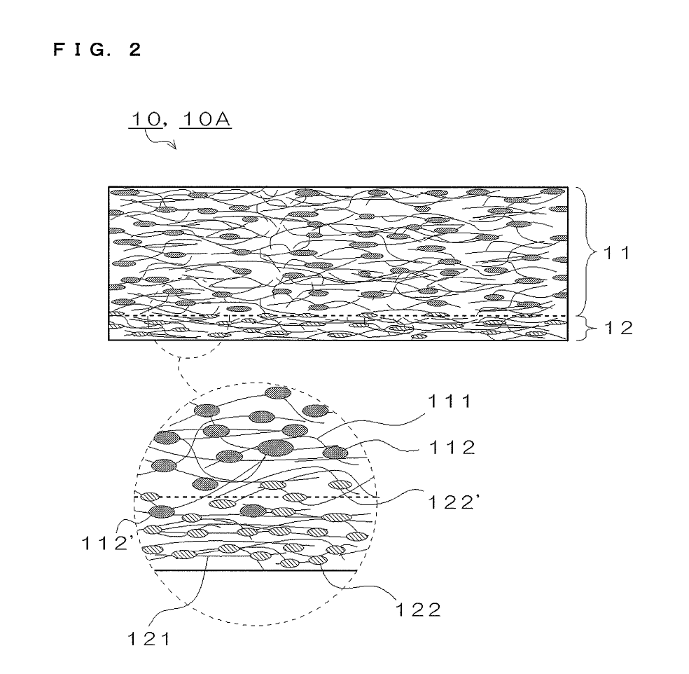

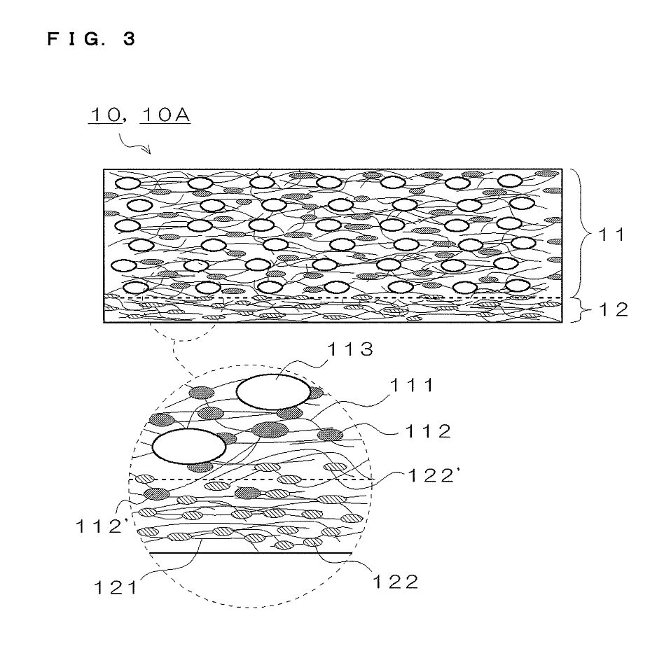

The vehicle component of the present invention is a structural article that includes a fibrous porous article 10A having a base layer 11 and a surface layer 12. FIGS. 2 and 3 show a cross-sectional structure of the fibrous porous article 10A including a base layer 11 and a surface layer 12 which is laminated to the surface of the base layer 11. The fibrous porous article 10A may have air permeability from a side of the surface layer 12 to a side of the base layer 11, and air permeability from a side of the base layer 11 to a side of the surface layer 12. The base layer 11 includes a plurality of glass fibers 111 and a portion (joint portion) 112 containing a first thermoplastic resin composition (hereinafter referred to as “first resin”) that binds the glass fibers 111. The surface layer 12 includes a plurality of resin fibers 121 and a portion (joint portion) 122 containing a second thermoplastic resin composition (hereinafter referred to as “second resin”) that binds the fiber fibers 121. FIG. 3 is an embodiment provided with an article (hereinafter referred to as “expanded body”) 113 which has a shell wall formed of a resin and contains a gas inside the shell wall (described layer). The first resin or second resin may include additives such as a filler, a plasticizer, an antioxidant, a UV absorber, an anti-aging agent, a flame retardant, a lubricant, a stabilizer, a weather resisting agent, an anti-static agent, a water repellent, an oil repellent, an antimicrobial agent, a preservative, and a coloring agent.

Preferable embodiments of the fibrous porous article 10A are as follows.

(1) The base layer 11 and surface layer 12 are bonded with the first resin, second resin or other adhesive agent.
(2) A space between the adjacent glass fibers 111 in the base layer 11, a space between the glass fibers 111 and the joint portions 112 in the base layer 11, a space between the adjacent resin fibers 121 in the surface layer 12, and a space between the resin fibers 121 and the joint portions 122 in the surface layer 12, communicate non-linearly to form communicating holes that allow gas to pass through from the surface of the surface layer 12 to the surface of the base layer 11.

The fibrous porous article 10A exhibits excellent rigidity when the fibrous porous article 10A has the above configuration. Since the communicating holes are formed non-linearly, a liquid such as water does not pass through the fibrous porous article 10A from the base layer 11 or the surface layer 12 to the other layer. This makes it possible to provide water resistance to the surface of the base layer 11 and the surface of the surface layer 12. In particular, water rarely penetrates into the base layer 11 from the surface layer 12.

A shape of the vehicle component 10 of the present invention is appropriately selected depending on the application thereof and is not particularly limited. For example, the vehicle component 10 may have a sheet-like shape including tabular sheet or curved sheet (e.g., semi-tubular sheet), a tubular shape, a container shape, an irregular shape, or the like. The thickness of the base layer 11 and thickness of the surface layer 12 in the fibrous porous article 10A may be constant over the entire vehicle component, or may vary depending on the application and the like. The vehicle component 10 of the present invention may have a plurality of areas that differ in thickness.

In the present invention, a relationship between a thickness D₁₁ of the base layer 11 and a thickness D₁₂ of the surface layer 12 is not particularly limited. From the viewpoint of rigidity, the relationship is preferably D₁₂<D₁₁, and particularly 2≦D₁₁/D₁₂≦30. The thickness D₁₁ of the base layer 11 is generally in the range from 2 to 15 mm.

The base layer 11 has a structure in which the glass fibers 111 are bound by the first resin. As illustrated in FIGS. 2 and 3, a space formed by the glass fibers 111 is not entirely filled with the first resin. Therefore, the fibrous porous article 10A allows air to pass through from the base layer 11 to the surface layer 12, and the vehicle component 10 exhibits an excellent noise-absorbing capability. The surface layer 12 has a structure in which the resin fibers 121 are bound by the second resin. Since a space formed by the resin fibers 121 is not entirely filled with the second resin in the same manner as that in the base layer 11, the fibrous porous article 10A allows air to pass through from the base layer 11 to the surface layer 12, and the vehicle component 10 exhibits an excellent noise-absorbing capability.

The base layer 11 includes, as shown in FIGS. 2 and 3, a plurality of the glass fibers 111, and the joint portions 112 that are formed of the first resin that binds the glass fibers 111. The joint portion 112 that is formed of the first resin is a binding area in which the glass fibers 111 are bound.

The type, shape, and size of the glass fibers 111 are not particularly limited. Various glass fibers may be used as the glass fibers 111. The diameter of the glass fibers 111 is preferably in the range from 5 to 9.75 μm. The content of the glass fibers 111 in the base layer 11 is not particularly limited, but is preferably in the range from 30% to 70% by mass, and more preferably from 40% to 60% by mass based on 100% by mass of the total of the glass fibers 111 and the first resin.

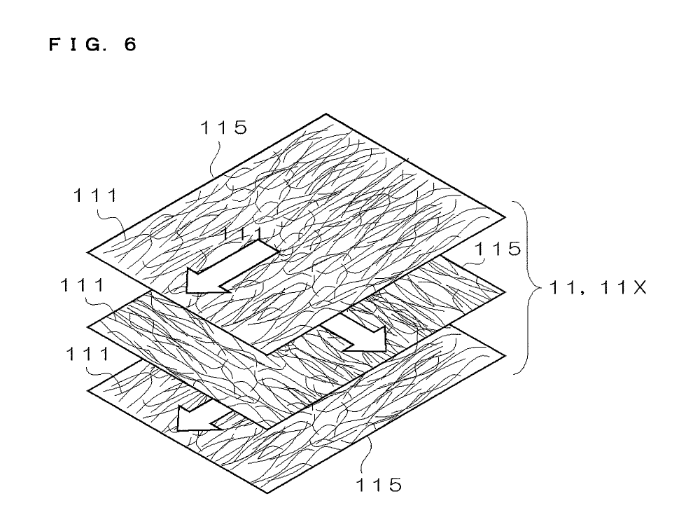

The glass fibers 111 may be included in the base layer 11 to have an arbitrary configuration. It may be possible to employ a configuration in which a plurality of glass fibers are aligned and regularly disposed in the longitudinal direction, a configuration in which a plurality of glass fibers are regularly disposed to draw a mesh pattern when a surface of a sheet-shaped base layer is viewed from above, or a configuration in which a plurality of glass fibers are randomly disposed. In the present invention, it is preferable that the base layer 11 has a structure formed by stacking a plurality of glass fiber sheets in which glass fibers are aligned in the longitudinal direction, wherein the glass fibers included in the adjacent glass fiber sheets intersect (cross) each other (see FIG. 6). FIG. 6 is a view illustrating the stacked-type base layer 11 in which the joint portion 112 formed of the first resin is omitted. The base layer 11 illustrated in FIG. 6 has a configuration in which three glass fiber sheets (glass fiber groups) 115 are stacked so that the glass fibers 111 included in the glass fiber sheets adjacent in the vertical direction differ in orientation direction (i.e., the direction indicated by the white arrow in FIG. 6), and the orientation direction of the glass fibers 111 included in one glass fiber sheet is almost perpendicular to the orientation direction of the glass fibers 111 included in the glass fiber sheet adjacent to the one glass fiber sheet. The number of glass fiber sheets (glass fiber groups) 115 stacked to form the base layer 11 is not particularly limited. For example, the number of glass fiber sheets (glass fiber groups) 115 may be in the range from 2 to 50. When the orientation direction of the glass fibers 111 included in one glass fiber sheet differs from the orientation direction of the glass fibers 111 included in the glass fiber sheet adjacent to the one glass fiber sheet, the angle formed by the glass fibers 111 is preferably in the range from 30° to 90°.

In the case of a fibrous porous article 10A having a base layer 11 that includes the glass fibers 111 and has the configuration illustrated in FIG. 6, it is possible to obtain a vehicle component which is excellent in mechanical properties, and mainly has a structure in which the glass fibers 111 included in one glass fiber sheet and the glass fibers 111 included in the glass fiber sheet adjacent to (on the upper side or the lower side of) the one glass fiber sheet are bound by the first resin. An excellent noise reduction effect can be obtained by increasing the thickness of the base layer 11. It is most preferable that the base layer 11 has a thickness equal to ¼th of the wavelength λ of noise in order to obtain a sufficient noise reduction effect. Noise (sound) having a longer wavelength can be reduced by increasing the thickness of the structural wall that includes the base layer 11 and the surface layer 12.

The first resin is a thermoplastic resin that binds the glass fibers 111. The content of the first resin in the base layer 11 is not particularly limited. The content thereof is preferably in the range from 30% to 70% by mass, and more preferably from 40% to 60% by mass based on 100% by mass of the total of the glass fibers 111 and the first resin.

A thermoplastic resin included in the first resin is not particularly limited so long as the resin is a thermoplastic resin that can adhere to and bind the glass fibers 111. Examples of the thermoplastic resin include a polyolefin resin, a polystyrene-based resin, an acrylic resin, and the like. The resins may be used singly or in combination of two or more types thereof. It is preferable to use a polyolefin resin from the viewpoint of adhesion to the glass fibers 111. The term “polyolefin resin” used herein includes an olefin homopolymer and an olefin copolymer. Examples of the olefin include ethylene, propylene, 1-butene, 3-methyl-1-butene, 1-pentene, 3-methyl-1-pentene, 4-methyl-1-pentene, 1-hexene, 1-octene, and the like. Specific examples of the polyolefin resin include a polyethylene-based resin, a polypropylene-based resin, poly(1-butene), poly(1-hexene), poly(4-methyl-1-pentene), and the like. The polyolefin resins may be used singly or in combination of two or more types thereof.

Examples of the polyethylene-based resin include an ethylene homopolymer, and a copolymer of ethylene and other olefin. Examples of the copolymer of ethylene and other olefin include an ethylene 1-butene copolymer, an ethylene 1-hexene copolymer, an ethylene 1-octene copolymer, an ethylene 4-methyl-1-pentene copolymer, and the like. Note that units derived from ethylene account for 50% or more by mole of the total structural units included in these copolymers.

Examples of the polypropylene-based resin include a propylene homopolymer, a propylene ethylene copolymer, a propylene 1-butene copolymer, and the like. Note that units derived from propylene account for 50% or more by mole of the total structural units included in these copolymers.

The base layer 11 may include an additional component other than the glass fibers 111 and the first resin. Examples of the additional component include the expanded body 113 illustrated in FIG. 3. The expanded body 113 includes a shell wall formed of a resin, and contains gas inside the shell wall. The expanded body 113 included in the base layer 11 has a definite shape or an indefinite shape. The expanded body 113 may have a spherical shape, an elliptical shape, or the like. Since the expanded body 113 is positioned between the glass fibers 111 (see FIG. 3), the expanded body 113 normally has an indefinite shape. There may be a case where each expanded body 113 has a different shape.

A gas contained in the expanded body 113 is not particularly limited. The gas contained in the expanded body 113 may be a gas that is expanded by heating, a gas derived from a thermally decomposable compound, or the like. Specifically, the expanded body 113 may be a resin foam particle containing an expansion gas, a product gas, or the like.

The expanded body 113 is preferably formed by heating an expandable particle such as a particle in which a thermally-expandable blowing agent (e.g., low-boiling-point hydrocarbon) is enclosed in a shell wall formed of a thermoplastic resin, to a temperature equal to or higher than the expansion start temperature, and allowing the thermally-expandable blowing agent that is expanded to push out the softened shell wall. The expanded body 113 is present in the base layer 11 at a position between the glass fibers 111 in a volume-expanded state.

A thermoplastic resin constituting the shell wall of the expanded body 113 is not particularly limited. It is preferable to use a thermoplastic resin having a melting point higher than the melting point of the first resin (i.e., the resin that is included in the base layer 11 and binds the glass fibers 111) and the melting point of the second resin (i.e., the resin that is included in the surface layer 12 and binds the resin fibers 121). For example, a copolymer or a homopolymer that includes a structural unit derived from an unsaturated nitrile compound such as acrylonitrile and methacrylonitrile may be used. Examples of the structural unit other than the structural unit for the copolymer include a structural unit derived from an unsaturated acid such as acrylic acid, an acrylate, a methacrylate, an aromatic vinyl compound, an aliphatic vinyl compound, vinyl chloride, vinylidene chloride, a crosslinkable monomer, and the like. The other structural units may be used singly or in combination of two or more types thereof. The copolymer may be a vinylidene chloride acrylonitrile copolymer.

When the base layer 11 includes the expanded bodies 113, it is preferable that the glass fibers 111 and the expanded bodies 113 are bound with the first resin. In this case, the expanded bodies 113 function as a light reinforcing material for the base layer 11. The expanded bodies 113 may not be bound with the first resin, and may be held between the glass fibers 111. When the base layer 11 includes the expanded bodies 113, the content of the expanded bodies 113 in the base layer 11 is not particularly limited. The content of the expanded bodies 113 is preferably in the range from 3 to 20 parts by mass based on 100 parts by mass of the total of the glass fibers and first resin from the viewpoint of lightweight and rigidity of the base layer 11 or vehicle component of the present invention.

When the base layer 11 includes the expanded bodies 113, the content of the glass fibers 111 can be reduced and the weight of the base layer 11 or the vehicle component of the present invention can be reduced while achieving high rigidity.

The surface layer 12 includes, as shown in FIGS. 2 and 3, a plurality of the resin fibers 121, and the joint portions 122 that are formed of the second resin that binds the resin fibers 121. The joint portion 122 that is formed of the second resin is a binding area in which the resin fibers 121 are bound.

Type, shape, and size of the resin fiber 121 are not particularly limited. A material of the resin fiber 121 is preferably a thermoplastic resin composition (hereinafter referred to as “third resin”). The content of the resin fibers 121 in the surface layer 12 is not particularly limited, but is preferably in the range from 30% to 70% by mass, and more preferably from 35% to 65% by mass based on 100% by mass of the surface layer 12.

A thermoplastic resin in the third resin is preferably a thermoplastic resin having a melting point higher than melting points of a thermoplastic resin in the second resin and a thermoplastic resin in the first resin.

The melting points of the thermoplastic resin in the first resin, the thermoplastic resin in the second resin, and the thermoplastic resin in the third resin are not particularly limited. It is preferable that the melting point of the thermoplastic resin in the third resin is higher than that of the thermoplastic resin in the second resin by 20° C. or more, and more preferably 50° C. or more. The upper limit of the melting point of the thermoplastic resin in the third resin is preferably (melting point of the thermoplastic resin in the second resin+160)° C. It is preferable that the melting point of the thermoplastic resin in the third resin is higher than that of the thermoplastic resin in the first resin by 20° C. or more, and more preferably 50° C. or more. The upper limit of the melting point of the thermoplastic resin in the third resin is preferably (melting point of the thermoplastic resin in the first resin+160)° C.

Examples of the thermoplastic resin in the third resin include a polyester resin containing an aromatic polyester resin such as polybutylene terephthalate and polyethylene terephthalate, and an aliphatic polyester resin such as polybutylene succinate, polyethylene succinate, and polylactic acid; a polyamide resin such as polyamide 6, polyamide 66, polyamide 612, polyamide 12, polyamide 6T, polyamide 6I, polyamide 9T, polyamide M5T, polyamide 11, polyamide 610, and polyamide 1010; a polycarbonate resin; and the like. The resins may be used singly or in combination of two or more types thereof.

A thermoplastic resin included in the second resin is not particularly limited so long as the resin is a thermoplastic resin that can adhere to and bind the resin fibers 121. The resin is preferably a thermoplastic resin of which the melting point satisfies the above relationships as the second resin. When the base layer 11 includes the expanded bodies 113, the second resin is preferably a thermoplastic resin having a melting point lower than the melting point of the material that forms the shell wall of the expanded bodies 113.

Examples of the thermoplastic resin in the second resin include a polyolefin resin, a polystyrene-based resin, an acrylic resin, and the like. Among these, a polyolefin resin is preferable from the viewpoint of adhesion to the resin fiber 121 including a polyester-based resin or the like that is a preferable material. Examples of the polyolefin resin include those mentioned above in connection with the first resin. The thermoplastic resin in the first resin and the thermoplastic resin in the second resin may be identical or different. The melting point of the thermoplastic resin in the second resin may be the same as the melting point of the thermoplastic resin in the first resin, or may be different from the melting point of the thermoplastic resin in the first resin.

The content of the second resin in the surface layer 12 is not particularly limited, but is preferably in the range from 30% to 70% by mass, and more preferably from 35% to 65% by mass based on 100% by mass of the surface layer 12.

As mentioned above, the base layer 11 and the surface layer 12 are preferably bonded to each other in the present invention. The base layer 11 and the surface layer 12 may be bonded in an arbitrary manner. The base layer 11 and the surface layer 12 may be bonded with the first resin and/or the second resin, or may be bonded with other adhesive agent.

The vehicle component 10 of the present invention may be used as various products (described later). For example, the vehicle component 10 may include a part having a thickness t₁, and a part having a thickness t₂, provided that 1.5≦t₂/t₁≦30 is satisfied. Specifically, the vehicle component 10 may include a plurality of parts (areas) that differ in thickness. When a structural wall is formed using a nonwoven fabric or the like that does not have rigidity sufficient to support itself, it is necessary to use a frame structure or a wire that serves as a support member. In this case, since the structural wall cannot have a sufficient thickness, sufficient rigidity cannot be obtained. Moreover, it is difficult to increase or decrease the thickness of the desired part while forming an integral structure. The vehicle component 10 of the present invention can solve the above problems. In addition, the vehicle component 10 can be foamed so that the desired part has a thickness required to reduce noise (i.e., a thickness equal to ¼th of the wavelength λ of the reduction target noise), and the fibrous porous article excellent in rigidity exhibits a noise-absorbing/silencing effect.

The ratio “t₂/t₁” may satisfy 2≦t₂/t₁≦10 or 2≦t₂/t₁≦6.

The thickness t₁ and the thickness t₂ are not particularly limited. The thickness t₂ is preferably in the range from 1 to 30 mm, more preferably from 2 to 20 mm, and particularly from 6 to 20 mm.

For example, it is considered that when the thickness of the wall of the duct in the center area of the straight duct is increased in the case of passing a sound having a noise level, the noise can be effectively reduced. Therefore, it is preferable to set the thickness of the duct at each open end to t₁, and set the thickness of the duct in the center area when trisecting the duct to t₂.

The fibrous porous article 10A according to the present invention preferably has communicating holes that are formed from the base layer 11 to the surface layer 12 by a space between the glass fibers 111 and a space between the resin fibers 121 that communicate non-linearly. An air permeability measured in accordance with JIS L 1096 (Frazier method) of the fibrous porous article 10A is preferably in the range from 1 to 25 cc/cm²/sec, and more preferably from 2 to 10 cc/cm²/sec from the viewpoint of sound (noise) insulation. It is preferable that the vehicle component 10 of the present invention include at least a part of the fibrous porous article 10A having an air permeability within the above range. A vehicle component that includes the fibrous porous article 10A having an air permeability of 2 to 6 cc/cm²/sec can reduce the sound pressure of engine intake pulsation noise and emission noise, for example.

The fibrous porous article 10A included in the vehicle component 10 of the present invention may have a through hole penetrating from a base layer side to a surface layer side. The fibrous porous article 10A according to the preferred embodiment has the communicating holes formed by the space between the glass fibers 111 and the space between the resin fibers 121 that communicate in a complicated manner. The fibrous porous article 10A may have a through hole that is formed through the fibrous porous article 10A from the base layer 11 to the surface layer 12 in order to obtain air permeability within the above preferable range. Noise can be reduced by providing such a through hole. For example, the air permeability by the through holes may be in the range from 2 to 10 cc/cm²/sec, and is particularly from 2 to 6 cc/cm²/sec.

The vehicle component 10 of the present invention may include an additional layer other than the base layer 11 and the surface layer 12. In this case, the vehicle component 10 may sequentially include the additional layer, the base layer 11, and the surface layer 12. The vehicle component 10 may have a configuration in which the surface layer 12 is provided on each side of the base layer 11.

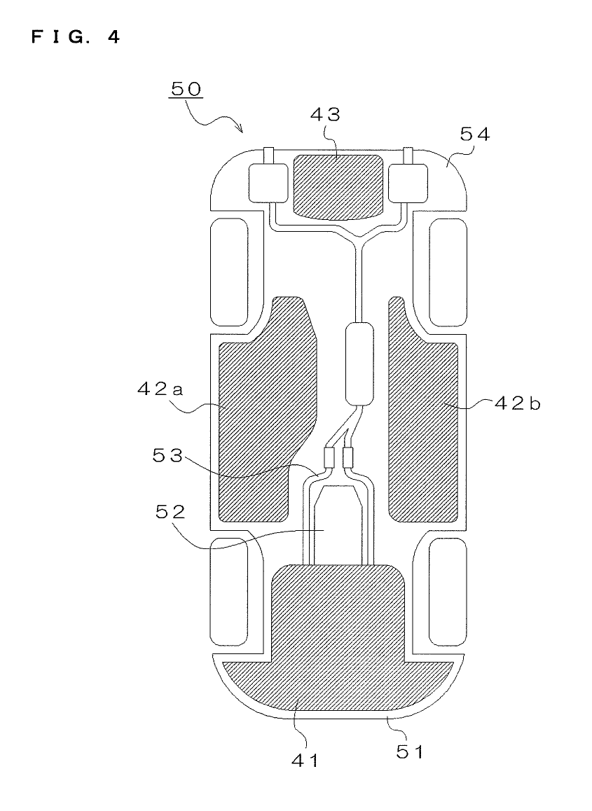

Examples of the vehicle component 10 of the present invention include an air duct, a filter case, an undercover (see FIG. 4), an engine cover, and the like. The air duct may be an air intake duct for feeding the open air to an automotive engine (including an inlet, a bent part, a bellows part, a straight pipe, and the like), a duct for introducing the open air into a vehicle, a duct provided to an air conditioner (e.g., a duct that is connected to the interior of a vehicle from an evaporator), a fan duct for feeding cooling air for cooling a vehicular storage battery, or the like. The filter case (filter case housing) includes a first-stage housing part in which an unfiltered gas circulates, a second-stage housing part in which a filtered gas circulates, a frame that holds a filter nonwoven fabric or the like.

The undercover may be an engine undercover, a floor undercover, a rear undercover, or the like.

The undercover shown in FIG. 4 is a component which is disposed on the lower side of a body 50 so that the undercover is positioned between the lower side of the body 50 and a road surface. An engine undercover 41 mainly covers the lower part of an engine. The engine undercover 41 may also cover the lower part of a front bumper 51, the lower part of a transmission 52, and the like. Floor undercovers 42a and 42b mainly cover the lower part of a passenger compartment. A pair of floor undercovers may be provided to avoid an exhaust pipe 53 that is subjected to a high temperature, and the like. A rear undercover 43 mainly covers the lower part of a rear bumper.

The vehicle component 10 of the present invention may be formed of only a fibrous porous article, or may be a composite that is obtained using a part that is formed of the fibrous porous article, and a part that is formed of other article.

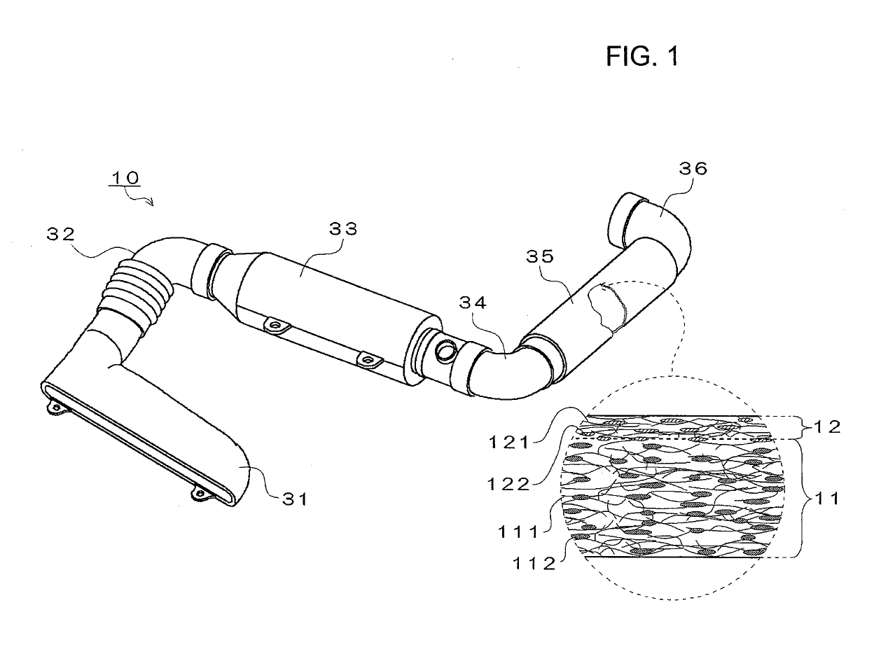

The fibrous porous article 10A is configured so that the surface layer 12 has density sufficient to function as a water-resistant layer while maintaining air permeability. For example, when forming a duct (e.g., noise-absorbing straight pipe 35) of the engine inlet system illustrated in FIG. 1 that is positioned on the downstream side of an air cleaner housing 33 (i.e., on the side closer to an engine) and allows clean air to flow through, it may be preferable that a foreign substance be not introduced from the outside of the inlet system as much as possible. In this case, the outer surface of the duct (e.g., noise-absorbing straight pipe 35) may be coated with a dustproof resin. Dustproof measures may also be taken by covering the duct (e.g., noise-absorbing straight pipe 35) with a dustproof cover, for example.

### 2. Production Method of Vehicle Component

The vehicle component of the present invention may be produced by an arbitrary method. According to the following production method, a vehicle component having the desired properties can be inexpensively obtained.

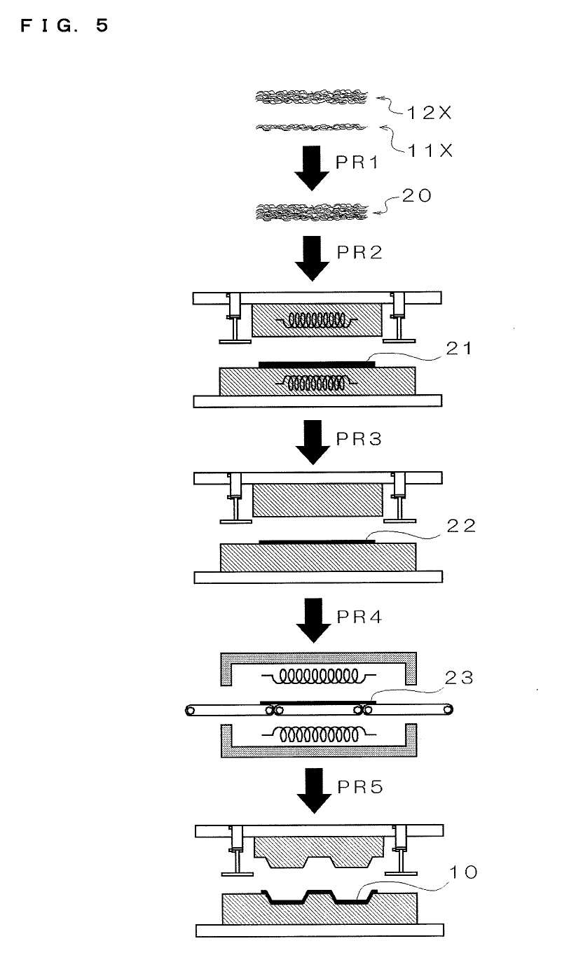

The preferable production method includes a laminate-forming process PR1 that stacks a nonwoven fabric for base layer 11X having a plurality of glass fibers 111 and a material (e.g., particulate material or fibrous material) consisting of the first resin, and a nonwoven fabric for surface layer 12X having a plurality of glass fibers 121 and a material (e.g., particulate material or fibrous material) consisting of the second resin, to form a nonwoven fabric laminate 20, a hot-pressing process PR2 that presses the nonwoven fabric laminate 20 at a temperature which is higher than the melting point of the thermoplastic resin in the first resin and the melting point of the thermoplastic resin in the second resin, and is lower than the melting point of the thermoplastic resin in the third resin to obtain a laminate 21, a first cold-pressing process PR3 that presses the laminate 21 obtained by the hot-pressing process PR2 without heating to obtain a laminate 22, a heating process PR4 that heats the laminate 22 obtained by the first cold-pressing process PR3 to obtain a laminate 23, and a second cold-pressing process PR5 that presses the laminate 23 obtained by the heating process PR4 to have the product shape (see FIG. 5).

According to the above method, the compressed laminate 21 can be densified while strongly integrating the nonwoven fabric for base layer 11X and the nonwoven fabric for surface layer 12X utilizing residual heat by subjecting the laminate 21 obtained by the hot-pressing process PR2 to the first cold-pressing process PR3. Moreover, the first resin can be sufficiently solidified in a state in which the glass fibers 111 are bound, and the second resin can be sufficiently solidified in a state in which the resin fibers 121 are bound. Therefore, mechanical properties and water resistance can be significantly improved as compared with the case where the first cold-pressing process PR3 is not provided. Since the first cold-pressing process PR3 is performed without heating, the surface layer 12 can be highly densified while maintaining the configuration of the resin fiber 121. Therefore, the first cold-pressing process PR3 leads to water resistance that can prevent a situation in which water penetrates into the base layer 11 from the surface layer 12 while advantageously maintaining the noise reduction effect of the vehicle component.

The nonwoven fabric for surface layer 12X used in the laminate-forming process PR1 is a nonwoven fabric material that includes the resin fibers 121 and the second resin. The nonwoven fabric material may be a nonwoven fabric (m1) including a plurality of resin fibers 121 that are not bound, and a second resin body (e.g., particles or fibers); a nonwoven fabric (m2) including a plurality of resin fibers 121 that are bound by the second resin; or the like. A surface layer excellent in water resistance can be formed using each nonwoven fabric material.

The details of the resin fiber 121 and the second resin constituting the second resin body are the same as those respectively described above. It is preferable that the resin fiber 121 includes the third resin containing a thermoplastic resin having a melting point higher than the thermoplastic resin in the second resin by 50° C. or more. The properties of the resin fibers 121 do not change during the production of the vehicle component, for example. The content of the resin fibers 121 and the content of the second resin body in the nonwoven fabric for surface layer 12X may respectively be 30% to 70% by mass and 30% to 70% by mass, and preferably 35% to 65% by mass and 35% to 65% by mass based on 100% by mass of the nonwoven fabric for surface layer 12X.

The basis weight of the nonwoven fabric for surface layer 12X is not particularly limited. For example, the basis weight thereof may be in the range from 100 to 400 g/m².

The nonwoven fabric for base layer 11X used in the laminate-forming process PR1 is a nonwoven fabric material that includes the glass fibers 111 and the first resin. The nonwoven fabric material may be a nonwoven fabric (n1) including a plurality of glass fibers 111 that are not bound, and a first resin body (e.g., particles or fibers); a nonwoven fabric (n2) including a plurality of glass fibers 111 that are bound with the first resin; a laminate obtained by stacking two or more nonwoven fabrics (n1) and/or nonwoven fabrics (n2); or the like. It is preferable to form the composite base layer 11 illustrated in FIG. 6 (i.e., a base layer that exhibits excellent mechanical properties) using a nonwoven fabric laminate obtained by stacking two or more glass fiber sheets (glass fiber groups) 115. The number of glass fiber sheets (glass fiber groups) 115 stacked to form the base layer 11 is not particularly limited. For example, the number of glass fiber sheets (glass fiber groups) 115 may be in the range from 2 to 50. It is preferable to use a nonwoven fabric laminate in which the glass fibers 111 included in the glass fiber sheets that are adjacent in the vertical direction intersect (cross) each other. In this case, the angle formed by the glass fibers 111 included in the glass fiber sheets that are adjacent in the vertical direction is preferably in the range from 30° to 90°.

The details of the glass fibers 111 and the first resin constituting the first resin body are the same as those respectively described above. The properties of the glass fibers 111 do not change during the production of the vehicle component, for example. The first resin that binds the glass fibers 111 may be included in the nonwoven fabric for base layer 11X to have an arbitrary configuration. For example, the first resin may be fibrous or particulate (pellets).

The first resin body and the second resin body may contain a different resin. It is preferable that the first resin body and the second resin body contain an identical thermoplastic resin so that the base layer 11 and the surface layer 12 can be bonded more firmly.

When the nonwoven fabric for base layer 11X includes the glass fibers 111 and the first resin body, the content of the glass fibers 111 and the content of the first resin body in the nonwoven fabric for base layer 11X respectively are preferably from 30% to 70% by mass and from 30% to 70% by mass, and more preferably from 40% to 60% by mass and from 40% to 60% by mass based on 100% by mass of the glass fibers 111 and the first resin body.

When the base layer 11 including expanded bodies 113 is formed, it is preferable to use the nonwoven fabric for base layer 11X that further includes expandable particles. The expandable particle is preferably a resin particle that has a shell wall formed of a thermoplastic resin that softens upon heating, and a blowing agent (e.g., low-boiling-point hydrocarbon) that expands in volume upon heating and is contained inside the shell wall. It is particularly preferable that the resin particle has an expansion start temperature that is higher than the melting point of the thermoplastic resin in the first resin and the melting point of the thermoplastic resin in the second resin, and is lower than the melting point of the thermoplastic resin in the third resin that forms the resin fibers 121 included in the nonwoven fabric for surface layer 12X. The lower limit of the expansion start temperature is preferably 200° C., and preferably 210° C. The upper limit of the expansion start temperature is normally 230° C.

When the nonwoven fabric for base layer 11X consists of the glass fibers 111, the expandable particles, and the first resin body, the content of the glass fibers 111 and the content of the first resin body in the nonwoven fabric for base layer 11X respectively are preferably from 30% to 70% by mass and from 30% to 70% by mass, and more preferably from 40% to 60% by mass and from 40% to 60% by mass based on 100% by mass of the glass fibers 111 and the first resin body. The content of the expandable particles in the nonwoven fabric for base layer 11X is preferably in the range from 3 to 20 parts by mass, and more preferably from 4 to 10 parts by mass based on 100 parts by mass of the total of the glass fibers 111 and the first resin body.

The basis weight of the nonwoven fabric for base layer 11X is not particularly limited. For example, the basis weight thereof may be in the range from 600 to 1,200 g/m².

The laminate-forming process PR1 is a process in which the nonwoven fabric for base layer 11X and the nonwoven fabric for surface layer 12X are stacked to form the nonwoven fabric laminate 20. The nonwoven fabric for base layer 11X and the nonwoven fabric for surface layer 12X may be stacked by an arbitrary method.

In FIG. 5, the nonwoven fabric for surface layer 12X is stacked on the nonwoven fabric for base layer 11X, however, the nonwoven fabric for base layer 11X may be stacked on the nonwoven fabric for surface layer 12X.

Hereinafter, a production method including processes PR1 to PR5 in the case where the nonwoven fabric for base layer 11X does not have the expandable particles is described below.

In the hot-pressing process PR2, the nonwoven fabric laminate 20 is pressed at a temperature that is higher than the melting point of the thermoplastic resin in the first resin and the melting point of the thermoplastic resin in the second resin, and is lower than the melting point of the thermoplastic resin in the third resin (i.e., the resin that forms the resin fibers 121). Specifically, the nonwoven fabric laminate 20 is hot-pressed while melting the first resin body and the second resin body. The first resin body included in the nonwoven fabric for base layer 11X is melted by hot pressing, and flows (is spread) within the compressed nonwoven fabric for base layer 11X to bond the glass fibers 111. The second resin body included in the nonwoven fabric for surface layer 12X is also melted by hot pressing, and flows (is spread) within the compressed nonwoven fabric for surface layer 12X to bond the resin fibers 121. The nonwoven fabric for base layer 11X and the nonwoven fabric for surface layer 12X are bonded to each other by the melted first resin and/or the melted second resin due to pressing (see 112′ and 122′ in FIG. 2). Since the resin fibers 121 are more flexible than the glass fibers 111 in general, the nonwoven fabric for surface layer 12X is easily densified. However, air permeability in the direction of the cross-section from one side to the other side of the laminate 21 is maintained. When the nonwoven fabric for surface layer 12X is disposed on the nonwoven fabric for base layer 11X (see FIG. 5), the melted second resin flows into the nonwoven fabric for base layer 11X during the hot-pressing process PR2, and the nonwoven fabric for base layer 11X and the nonwoven fabric for surface layer 12X are bonded mainly with the second resin. When the nonwoven fabric for base layer 11X is disposed on the nonwoven fabric for surface layer 12X, the nonwoven fabric for base layer 11X and the nonwoven fabric for surface layer 12X are bonded mainly with the first resin.

The laminate 21 shown in FIG. 5 has a sheet-like shape. The laminate 21 having the desired shape may be formed by pressing the nonwoven fabric laminate 20 using a mold having a recess or a protrusion at a temperature at which the first resin and the second resin melt, but the resin fibers 121 do not melt.

In the hot-pressing process PR2, when the first resin body included in the nonwoven fabric for base layer 11X and the second resin body included in the nonwoven fabric for surface layer 12X contain a polyolefin resin having a melting point of 100° C. to 180° C., and a material of the resin fibers 121 included in the nonwoven fabric for surface layer 12X is a polyester-based resin having a melting point of 220° C. to 280° C., the hot press temperature (i.e., the maximum temperature that is reached when pressing the nonwoven fabric laminate 20) may be in the range from 160° C. to 210° C. that is higher than a temperature that exceeds the melting point of the thermoplastic resin in the first resin body and the melting point of the thermoplastic resin in the second resin body by 30° C. to 60° C.

The first cold-pressing process PR3 is a process in which the laminate 21 obtained by the hot-pressing process PR2 is cold-pressed. In this process, the laminate 21 is preferably cold-pressed in the shape of a sheet (tabular shape) without heating the laminate 21 in a state in which residual heat due to the hot-pressing process PR2 is present. The water resistance at the surface layer 12 can be improved while maintaining a high noise-absorbing capability by providing the first cold-pressing process PR3.

It is considered that the above effect is achieved by the first cold-pressing process PR3 since the base layer 11 and the surface layer 12 that are compressed by the hot-pressing process PR2 are further compressed, so that the first resin and the second resin are sufficiently solidified, and the entire laminate 22 is densified. In particularly, the resin fibers 121 included in the surface layer 12 that has residual heat can be firmly bound with the solidified second resin, and a dense structure can be formed by pressing while ensuring air permeability. Moreover, it is possible to obtain water resistance that prevents water from penetrating from the surface layer 12 to the base layer 11. Since the surface layer 12 includes the resin fibers 121, the laminate 22 exhibits moderate flexibility even after the surface layer 12 has been densified. This makes it possible to form a fibrous porous article that exhibits high rigidity so that the surface of the surface layer 12 does not break even if a tool and the like hits the surface of the surface layer 12.

In the case of using the nonwoven fabric for base layer 11X obtained by stacking two or more glass fiber sheets (glass fiber groups) 115 so that the orientation directions of the glass fibers 111 intersect each other in order to form the base layer 11 illustrated in FIG. 6, the number of points at which the glass fibers 111 are bound with the first resin increases. Therefore, delamination of the glass fiber sheets in the base layer 11 can be prevented to obtain a fibrous porous article excellent in mechanical properties.

The heating process PR4 is a process in which the laminate 22 obtained by the first cold-pressing process PR3 is heated. More specifically, the laminate 22 is heated to such an extent that flexibility necessary for molding in the second cold-pressing process PR5 (the process means a cold press process and a molding process) is obtained. In the heating process PR4, it is preferable to heat the laminate 22 at a temperature lower than the melting point of the thermoplastic resin in the first resin or the melting point of the thermoplastic resin in the second resin, whichever is higher, by 10° C. or more. The lower limit of the heating temperature is particularly a temperature lower than the melting point of the thermoplastic resin in the first resin or the melting point of the thermoplastic resin in the second resin, whichever is higher, by 60° C. The heating method used in the heating process PR4 is not particularly limited. A known heating method that utilizes a hot blast, a heating plate, infrared rays, or the like may be employed.

In the case of using the nonwoven fabric for base layer 11X that does not include the expandable particles 113, the bulkiness of the base layer 11 can be increased due to a spring back phenomenon (i.e., the constraint of the glass fibers 111 by the first resin is reduced to some extent due to heating), and a fibrous porous article that exhibits high rigidity can be obtained.

In the second cold-pressing process PR5, the heated laminate 23 is molded into the end product (vehicle component) or a partial body consisting of the fibrous porous article by cold-pressing the laminate 23 using a mold or the like.

The vehicle component 10 shown in FIG. 5 has a uniform thickness. When utilizing a cavity that has a part having a different thickness, or selecting the degree of compression during pressing, a specific part can be provided with the desired thickness.

Next, a production method in the case where the nonwoven fabric for base layer 11X includes the expandable particles is described from the process PR2.

In the hot-pressing process PR2, the nonwoven fabric laminate 20 that includes the nonwoven fabric for base layer 11X having the expandable particles is pressed (compressed) at a temperature that is higher than the melting point of the thermoplastic resin in the first resin and the melting point of the thermoplastic resin in the second resin, is lower than the melting point of the thermoplastic resin in the third resin (i.e., the resin that forms the resin fibers 121), and is lower than the expansion start temperature of the expandable particles. Specifically, the nonwoven fabric laminate 20 is hot-pressed while melting the first resin body and the second resin body without causing the expandable particles to expanded body to obtain the laminate 21. The first resin body included in the nonwoven fabric for base layer 11X is melted by hot pressing, and flows (is spread) within the compressed nonwoven fabric for base layer 11X to bond the glass fibers 111 and bond the glass fibers 111 and the expandable particles. The second resin body included in the nonwoven fabric for surface layer 12X is also melted by hot pressing, and flows (is spread) within the compressed nonwoven fabric for surface layer 12X to bond the resin fibers 121. The nonwoven fabric for base layer 11X and the nonwoven fabric for surface layer 12X are bonded to each other by the melted first resin and/or the melted second resin due to pressing (see 112′ and 122′ in FIG. 3). The surface layer 12 is densified, but the laminate 21 maintains air permeability in the direction of the cross-section from one side to the other side.

When the first resin body included in the nonwoven fabric for base layer 11X and the second resin body included in the nonwoven fabric for surface layer 12X are formed of a polyolefin resin having a melting point of 100° C. to 180° C., the expansion start temperature of the expandable particles included in the nonwoven fabric for base layer 11X is 190° C., and the resin fibers 121 included in the nonwoven fabric for surface layer 12X are formed of a polyester-based resin having a melting point of 220° C. to 280° C., the hot press temperature employed in the hot-pressing process PR2 may be set to a temperature that is lower than the expansion start temperature of the expandable particles by 10° C. or more, and is higher than the melting point of the thermoplastic resin in the first resin or the melting point of the thermoplastic resin in the second resin, whichever is higher, by 10° C. or more.

In the first cold-pressing process PR3, the laminate 21 is cold-pressed in the same manner as those in the case of using the nonwoven fabric for base layer 11X that does not include the expandable particles to obtain the laminate 22. The effect achieved by the first cold-pressing process PR3 is the same as that achieved when using the nonwoven fabric for base layer 11X that does not include the expandable particles.

In the heating process PR4, the laminate 22 is heated. The first resin and the second resin are melted by heating, so that the laminate 22 softens, and the expandable particles expand in volume to form the expanded bodies (resin foam particles) 113. The expanded bodies 113 and the glass fibers 111 are bound by the melted first resin to obtain the laminate 23. The heating temperature employed in the heating process PR4 is set to a temperature that is lower than the melting point of the resin constituting the resin fibers 121 included in the nonwoven fabric for surface layer 12X, and is equal to or higher than the expansion start temperature of the expandable particles.

Since the expandable particles expand due to the heating process PR4, the bulkiness of the base layer 11 can be increased, and a fibrous porous article having high rigidity can be obtained.

After that, the heated laminate 23 is molded into the end product (vehicle component) or a partial body consisting of the fibrous porous article by cold-pressing the laminate 23 using a mold or the like in the second cold-pressing process PR5.

In the second cold-pressing process PR5, the expanded bodies 113 repulse in the base layer 11 when the laminate 23 that includes the base layer 11 including the expanded bodies 113 and the surface layer 12 is subjected to cold pressing, so that the desired thickness can be maintained. Therefore, a fibrous porous article having the desired thickness and being excellent in rigidity can be obtained.

A fibrous porous article produced using the nonwoven fabric for base layer 11X that includes the expandable particles has a reduced weight as compared with a fibrous porous article produced using the nonwoven fabric for base layer 11X that does not include the expandable particles when the thickness of the fibrous porous article is identical.

The above preferable production method may include an additional process other than the processes PR1 to PR5. Examples of the additional process include a trimming process that trims the laminate into the product shape, an assembly process that disposes another part, an air permeability adjustment process that adjusts the air permeability from one side to the other side of the fibrous porous article, and the like.

Although an example in which the nonwoven fabric for base layer 11X and the nonwoven fabric for surface layer 12X are respectively used to form the base layer 11 and the surface layer 12 is described above, the laminate-forming process PR1 may be performed using a nonwoven fabric for base layer in which the glass fibers 111 and the expandable particles are bound with the first resin, and a nonwoven fabric for surface layer in which the resin fibers 121 are bound with the second resin.

### EXAMPLES

### 1. Production and Evaluation of Vehicle Component

In Example 1, a sheet-like body having a constant thickness was produced. In Example 2, an inlet 31, a joint 32, an air cleaner housing 33, a joint 34, a noise-absorbing straight pipe 35, and a joint 36 that form an automotive air intake system 10 (see FIG. 1), and a half-segmented formed body used to form these parts were produced. In Example 3, an engine undercover 41, floor undercovers 42a and 42b, and a rear undercover 43 that are disposed on the lower side of the body of an automobile (see FIG. 4) were produced.

Starting material of nonwoven fabrics for the above articles are as follows.

### 1-1. Nonwoven Fabric for Base Layer 11X

The nonwoven fabric for base layer 11X was a sheet having a thickness of about 5 mm prepared by stacking two glass fiber sheets so that the orientation directions of the glass fibers included in the respective glass fiber sheets intersected almost perpendicularly.

Each glass fiber sheet contained glass fibers, resin particles that were held between the glass fibers and formed of a polypropylene resin as the first resin, and expandable particles having an expansion start temperature of 190° C., and had a basis weight of 1,100 g/m².

The content of the glass fibers, the content of the resin particles, and the content of the expandable particles were respectively 41.5% by mass, 51% by mass, and 7.5% by mass based on 100% by mass of the nonwoven fabric for base layer 11X.

### 1-2. Nonwoven Fabric for Surface Layer 12X

The nonwoven fabric for surface layer 12X was a sheet prepared by mixing high-melting-point resin fibers (resin fibers 121) formed of a polyethylene terephthalate resin as the second resin and low-melting-point resin fibers (resin fibers formed of a third resin that binds the high-melting-point resin fibers) formed of a polypropylene resin, and had a basis weight of 1,300 g/m² and a thickness of about 1 mm.

The content of the high-melting-point resin fibers and the content of the low-melting-point resin fibers were respectively 50% by mass and 50% by mass based on 100% by mass of the nonwoven fabric for surface layer 12X.

### Example 1

### (1) Laminate-Forming Process (PR1)

The nonwoven fabric for base layer 11X and the nonwoven fabric for surface layer 12X were stacked to obtain a nonwoven fabric laminate 20.

### (2) Hot-Pressing Process (PR2)

The nonwoven fabric laminate 20 obtained by the process (1) was hot-pressed for 30 seconds using a steam platen press at a temperature of 190° C. and a pressure 5 kg/cm² to obtain a sheet-like laminate 21 having a thickness of about 2 mm in which the nonwoven fabric for base layer 11X and the nonwoven fabric for surface layer 12X were bonded to each other.

### (3) First Cold-Pressing Process (PR3)

The laminate 21 obtained by the process (2) was pressed (compressed) for 30 seconds using a cold press at a temperature of 210° C. and a pressure 5 kg/cm² to obtain a sheet-like laminate 22 having a thickness of about 5 mm.

### (4) Heating Process (PR4)

The laminate 22 obtained by the process (3) was placed in a hot-blast thermostat bath set to temperature of 210° C. to obtain a laminate 23 having a thickness of about 15 mm in which the expandable particles were expanded.

### (5) Second Cold-Pressing Process (PR5)

The laminate 23 obtained by the process (4) was pressed (compressed) using a cold press to obtain a sheet-like body (i.e., a vehicle component including a fibrous porous article) having a thickness of 8.5 mm.

The resulting sheet-like body (vehicle component) was evaluated as described below (see (A) and (B)).

### (A) Tensile Strength

The tensile strength of the sheet-like body having a dumbbell shape (width of measurement area: 10 mm) was measured using a universal tester “Autograph” (manufactured by Shimadzu Corporation) in accordance with JIS K 7161. Since the base layer was formed using two glass fiber sheets, the tensile strength was measured while changing the tensile direction by 90°. The tensile strength of the sheet-like body measured in each direction was higher than the tensile strength of a sheet-like body formed of polypropylene by a factor of 1.27 to 1.28. It was thus confirmed that the sheet-like body obtained in Example 1 exhibited excellent mechanical properties, and can be used as a structural member.

### (B) Flexural Rigidity

A specimen (50 mm×200 mm×8.5 mm) was placed on the support stage (span: 100 mm) of a tester, and the maximum flexural load when the center of the specimen in the longitudinal direction was pressed downward by 30 mm (from the horizontal position) was measured. The maximum flexural load of the specimen was higher than the maximum flexural load of a sheet-like body formed of polypropylene by a factor of 2.25. It was thus confirmed that the sheet-like body obtained in Example 1 exhibited excellent mechanical properties, and can be used as a structural member.

### Example 2

The processes (1) to (4) were performed in the same manner as those in Example 1. In the process (5) (second cold-pressing process (PR5)), the laminate 23 was pressed (compressed) using a cold press having a cavity for a half-segmented formed body for forming a product (inlet 31, joint 32, air cleaner housing 33, joint 34, noise-absorbing straight pipe 35, and joint 36) to obtain two half-segmented formed bodies which has a surface layer at outer surface and has a thickness at a thick part of 8.5 mm. The two half-segmented formed bodies are bonded at the edge to produce the above product (i.e., a vehicle component including a fibrous porous article).

The half-segmented formed bodies for each of the inlet 31, joint 32, air cleaner housing 33, joint 34, noise-absorbing straight pipe 35, and joint 36 were bonded to obtain cylindrical bodies for them and the cylindrical bodies were assembled to produce the air intake system 10 shown in FIG. 1.

The resulting cylindrical body was evaluated for water resistance.

### (C) Water Resistance

The cylindrical body having a diameter of 60 mm and length of 300 mm was placed at a temperature of 25° C. in the atmosphere and water was continuously sprayed onto the outer surface (surface layer). The inner surface of the cylindrical body was observed after 5 minutes and the base layer was not wetted.

The resulting air intake system 10 was evaluated as described below (see (D) and (E)) to evaluate noise reduction effect.

### (D) Sound Pressure Level Measurement (1)

The joint 36 of the air intake system 10 was connected to the throttle body of a 4-cylinder engine (displacement: 1.8 L) to prepare a tester (T1).

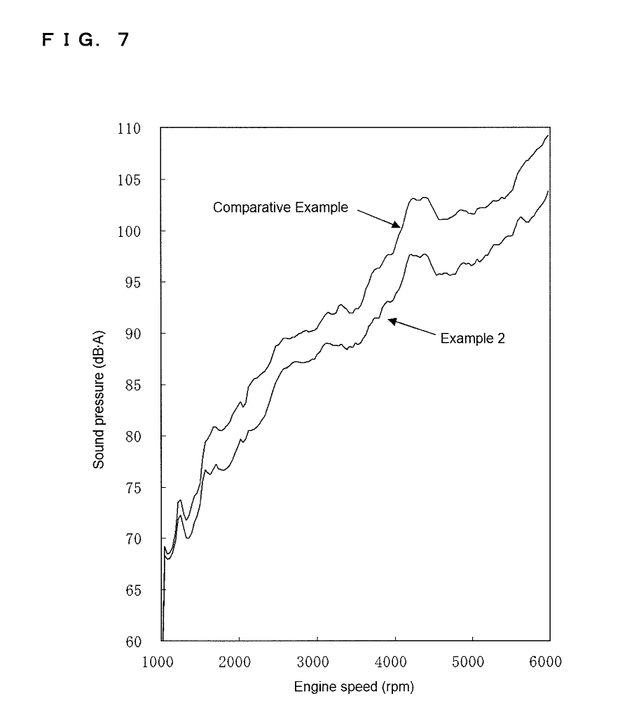

The tester (T1) was placed in an anechoic chamber, and a microphone connected to an FFT analyzer was secured in front of the opening of the inlet 31. The engine was then started to measure the A-scale sound pressure level when the engine speed was increased from 1,000 rpm to 6,000 rpm. The results are shown in FIG. 7. FIG. 7 is a graph in which the horizontal axis indicates the engine speed, and the vertical axis indicates the measured A-scale sound pressure level. Note that an air intake system obtained by assembling an inlet 31, a joint 32, an air cleaner housing 33, a joint 34, a noise-absorbing straight pipe 35, and a joint 36 that were produced using a polypropylene resin and were solid was also subjected to the measurement for Comparative Example. The results are shown in FIG. 7. As shown in FIG. 7, an excellent noise reduction effect was obtained over the entire engine speed range (1,000 rpm) when using the air intake system 10 having the configuration according to the invention.

### (E) Sound Pressure Level Measurement (2)

Six types of noise-absorbing straight pipes 35 (air permeability from surface layer to base layer: 1 to 25 cc/cm²/sec) were prepared under different production conditions. An air intake system 10 was provided in the same manner as those in (D). Note that the inlet 31, joint 32, air cleaner housing 33, joint 34, and joint 36 had an air permeability of 4 cc/cm²/sec.

The joint 36 of the air intake system 10 was connected to a speaker instead of the throttle body of the engine described in (D) to prepare a tester (T2).

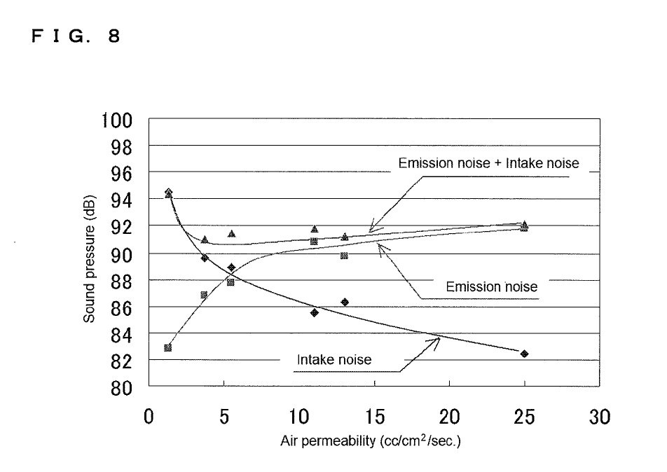

The tester (T2) was placed in an anechoic chamber, and a microphone connected to an FFT analyzer was secured in front of the opening of the inlet 31. White noise was emitted from the speaker to measure the A-scale sound pressure level corresponding to intake noise of an actual product (speaker vibration method). The intake noise curve (i.e., the measurement results obtained in front of the opening of the inlet 31) shown in FIG. 8 indicates the correlation between the air permeability (horizontal axis) and measured A-scale sound pressure level (vertical axis). The above measurement was performed using each noise-absorbing straight pipe 35.

The microphone was then moved to a position near the outer circumferential surface of the joint 32. White noise was emitted from the speaker to measure the A-scale sound pressure level corresponding to emission noise of an actual product (speaker vibration method). The emission noise curve (i.e., the measurement results obtained near the outer circumferential surface of the joint 32) shown in FIG. 8 indicates the correlation between the air permeability (horizontal axis) and measured A-scale sound pressure level (vertical axis). The above measurement was performed using each noise-absorbing straight pipe 35.

FIG. 8 is a curve of the sum of emission noise and intake noise based on the results. As shown in FIG. 8, the emission noise+intake noise curve has a minimum within the air permeability range of 2 to 6 cc/cm²/sec at which the sound pressure level is most effectively reduced. Specifically, it was confirmed that the air intake system 10 including the noise-absorbing straight pipe 35 for which the air permeability was adjusted to 2 to 6 cc/cm²/sec, could effectively reduce the intake noise and emission noise.

### Example 3

The undercovers illustrated in FIG. 4 (i.e., (1) engine undercover 41, (2) floor undercovers 42a and 42b, and (3) rear undercover 43) were obtained by performing the processes (1) to (5) in the same manner as those in Example 1.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

1. A vehicle component comprising a fibrous porous article,
wherein said fibrous porous article comprises a base layer and a surface layer which is bonded to a surface of said base layer,
wherein said base layer comprises a plurality of glass fibers and a first thermoplastic resin that binds said glass fibers, and
wherein said surface layer comprises a plurality of resin fibers and a second thermoplastic resin that binds said resin fibers.

2. The vehicle component according to claim 1,
wherein said base layer comprises an expanded body.

3. The vehicle component according to claim 1,
wherein said fibrous porous article comprises a portion having a thickness t₁ and a portion having a thickness t₂, provided that 2≦t₂/t₁≦10 is satisfied.

4. The vehicle component according to claim 1, further comprising a through hole penetrating from a base layer side to a surface layer side.

5. The vehicle component according to claim 1, which is an air feed duct, a filter case, an undercover, or an engine cover.
